(19) United States
(12) Patent Application Publication
(10) Pub. No.: US 2011/0244736 A1
(43) Pub. Date: Oct. 6, 2011

(54) FEMALE ELECTRICAL CONTACT PIN

(76) Inventors: Stephen Howard Clark, New Lenox, IL (US); Kevin L. Russelburg, Bolingbrook, IL (US)

(21) Appl. No.: 13/022,394

(22) Filed: Feb. 7, 2011

Related U.S. Application Data
(60) Provisional application No. 61/319,649, filed on Mar. 31, 2010.

(51) Int. Cl. H01R 13/24; H01R 43/16

(52) U.S. Cl. 439/824; 29/874

(57) ABSTRACT

A female contact pin configured for use with a compliant pin system includes opposed contact beams separated by an opening, and spring-biased mating contacts surrounded by a protective box. The opposed contact beams are configured to be positioned within a plated thru hole. The opening closes when the opposed contact beams are positioned within the plated thru hole. The spring-biased mating contacts are configured to receive and contact a mating post of a male contact pin.

### RELATED APPLICATIONS

This application relates to and claims priority benefits from U.S. Provisional Patent Application No. 61/319,649 entitled “Compliant Pin Having Box-Type Interface,” filed Mar. 31, 2010, which is hereby incorporated by reference in its entirety.

### FIELD OF EMBODIMENTS OF THE INVENTION

Embodiments of the present invention generally relate to compliant pin systems and methods of forming electrical connections between an electrical contact and a circuit board, and, more particularly, to a box-type female electrical contact pin.

### BACKGROUND

Compliant pin technology is used to form solder-less electrical connections between electrical contacts and circuit boards. The compliant portion of a pin is configured to flex as it is urged into the circuit board. Due to the flexing nature of the pin, the mating hole within the circuit board is not damaged during pin insertion.

FIG. 1 illustrates an isometric view of a male contact pin 10. The pin 10 includes a solid mating post 12 integrally formed with and connected to a shoulder 14, which is, in turn, integrally formed with and connected to opposed contact beams 16, which are, in turn, integrally connect to a stud 18. The contact beams 16 are separated by an opening 20 referred to as an “eye of the needle” (“EOTN”).

In operation, the mating post 12 is configured to mate and electrically connect with a reciprocal female reception member of a female contact pin (not shown in FIG. 1). As the male contact pin 10 is inserted into a mating hole of a circuit board, the opposed contact beams 16 flex together and the EOTN separating the contact beams 16 closes. The mating hole of the circuit board is generally a plated thru hole, which is plated with layers of copper and tin. The shoulder 14 has an axial cross-sectional area larger than the mating hole of the circuit board, and, therefore, is unable to pass therein.

Typically, the diameter of the mating hole of the circuit board is 0.040″ or 1 mm. Such a mating hole is an industry standard size for a plated thru hole.

EOTN compliant pins are typically male contact pins, such as the male contact pin 10. Such pins are referred to as compliant pins because the EOTN flexes when it is urged into a plated thru hole.

The thickness t of the male contact pin 10 is typically 0.025″. This thickness is used as an industry standard to achieve proven results with the EOTN geometry, although slight deviations in thickness are common.

In general, forming limitations of the contact material prevent the 0.025″ material to be formed into a protective box-type design.

### SUMMARY OF EMBODIMENTS OF THE INVENTION

Certain embodiments of the present invention provide a female contact pin configured for use with a compliant pin system. The female contact pin includes opposed contact beams separated by an opening. The opposed contact beams are configured to be positioned within a plated thru hole. The opening closes when the opposed contact beams are positioned within the plated thru hole. The female contact pin also includes spring-biased mating contacts surrounded by a protective box. The spring-biased mating contacts are configured to receive and contact a mating post of a male contact pin.

The opposed contact beams, the spring-biased mating contacts, and the protective box may be integrally formed together from a single piece of material. The thickness of the single piece of material may be 0.0125″.

The opposed contact beams may be formed through overlapping legs. The thickness of the opposed contact beams may be 0.025″.

The protective box may be formed from a planar wall being folded around the spring-biased mating contacts. The planar wall may include at least one tab and at least one reciprocal notch configured to receive the tab.

Certain embodiments of the present invention provide a method of forming a female contact pin configured for use with a compliant pin system. The method includes integrally forming first and second legs and a planar wall from a single piece of material, wherein each of the first and second legs includes opposed contact beam members having an opening formed therebetween. The method also includes bending first and second mating contact members over the planar wall, folding the first and second legs onto one another to form opposed contact beams, wherein the openings of each of the first and second legs are aligned with one another, and shaping the planar wall to form a protective box around the mating contacts.

Certain embodiments of the present invention provide a female contact pin configured for use with a compliant pin system. The female contact pin includes overlapping legs that define opposed contact beams separated by an eye of the needle opening. The opposed contact beams are configured to be received and retained within a plated thru hole. The female contact pin also includes spring-biased mating contacts surrounded by a protective box. The spring-biased mating contacts are configured to electrically connect to a mating post of a male contact pin.

### BRIEF DESCRIPTION OF SEVERAL VIEWS OF THE DRAWINGS

FIG. 1 illustrates an isometric view of a male contact pin.

FIG. 2 illustrates an isometric top view of a preformed female contact pin, according to an embodiment of the present invention.

FIG. 3 illustrates an isometric top view of a female contact pin, according to an embodiment of the present invention.

FIG. 4 illustrates a lateral view of a female contact pin, according to an embodiment of the present invention.

FIG. 5 illustrates a front view of a female contact pin, according to an embodiment of the present invention.

FIG. 6 illustrates a cross-sectional view of a female contact pin through line 6-6 of FIG. 5, according to an embodiment of the present invention.

FIG. 7 illustrates an isometric exploded view of an electrical system, according to an embodiment of the present invention.

FIG. 8 illustrates a transverse cross-sectional view of an electrical system, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

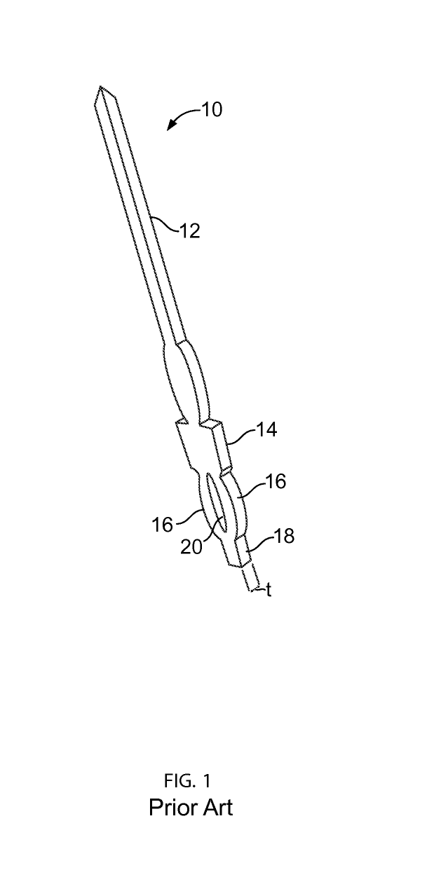

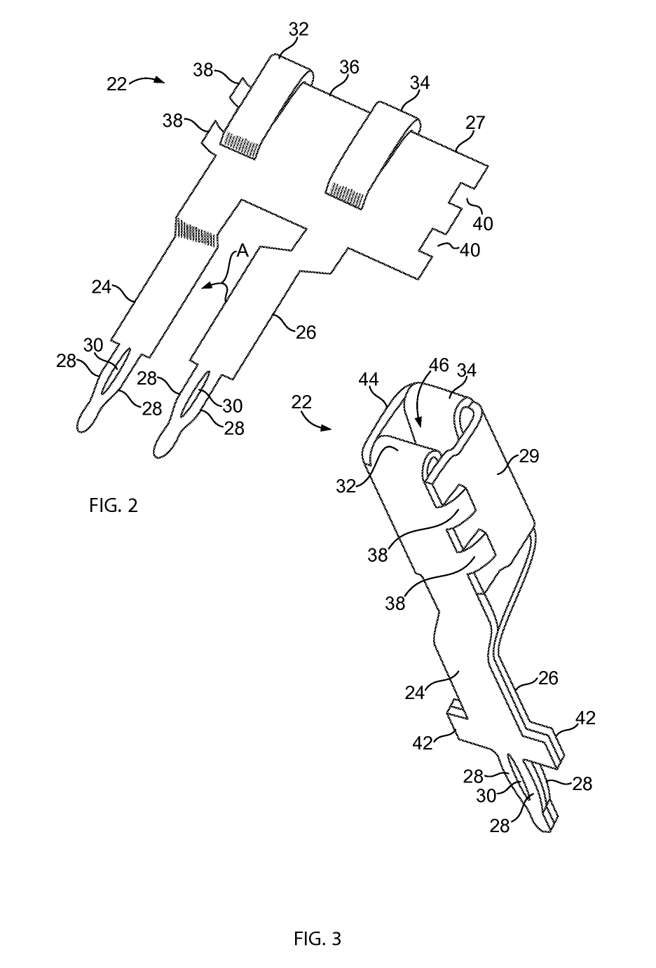

FIG. 2 illustrates an isometric top view of a preformed female contact pin 22, according to an embodiment of the present invention. The female contact pin 22 is formed from a single piece of material, such as a conductive metal, having a thickness that is generally half that of an EOTN male contact pin (such as the male contact pin 10, shown in FIG. 1). For example, the material may have a thickness of 0.0125″.

The preformed female contact pin 22 includes first and second legs 24 and 26 integrally formed with and connected to a planar wall 27. The first and second legs 24 and 26 include opposed contact beams 28 at distal ends. The respective opposed contact beams 28 are separated by openings 30.

First and second mating contacts 32 and 34, respectively, are folded over a surface 36 of the planar wall 27. After being folded over, the mating contacts 32 and 34 are separated from the surface 36 of the planar wall 27 by spaces. That is, while the mating contacts 32 and 34 are bent and folded so that they are positioned over the surface 36, the mating contacts 32 and 34 do not touch the surface 36.

Tabs 38 are formed at a lateral edge of the planar wall 27. Notches 40 are formed in the planar wall 27 at an opposite lateral edge as the tabs 38.

In order to form the female contact pin 22, the second leg 26 is folded onto the first leg 24 in the direction of arrow A. The second leg 26 is folded onto the first leg 24 so that the second leg 26 is nested into the first leg 24. Optionally, the first leg 24 can be folded onto the second leg 26 in a direction opposite that of arrow A.

During this folding process, the wall 27 follows along as the second leg 26 is folded onto the first leg 24. As such, the first and second mating contacts 32 and 34 are folded toward one another. The planar wall 27 is then further folded so that the notches 40 receive the tabs 38, thereby forming a box around the first and second mating contacts 32 and 34, which now oppose one another.

FIG. 3 illustrates an isometric top view of the female contact pin 22, according to an embodiment of the present invention. As shown, the female contact pin 22 has been fully formed, such that the second leg 26 is folded onto the first leg 24. Because the thickness of each leg is generally half the thickness of a conventional male contact pin (such as shown in FIG. 1), the overlapping of the first and second legs 24 and 26 produces a thickness that is acceptable for compliant pin applications. That is, the overlapped legs 24 and 26 yield a thickness of 0.025″, for example.

The EOTN is formed by the aligned openings 30 of the first and second legs 24 and 26. As shown in FIG. 3, the female contact pin 22 may also optionally be formed with a crossbeam 42 (although this is not shown in FIG. 2). The crossbeam 42 may provide a more robust shoulder that prevents the female contact pin 22 from being inserted too far into a plated thru hole.

The folded planar wall 27 forms a protective box 44 around opposed mating contacts 32 and 34. The mating contacts 32 and 34 are separated within the formed box 44 by a clearance area 46. A mating post of a male contact pin is configured to be positioned within the clearance area 46 and make contact with both the mating contacts 32 and 34.

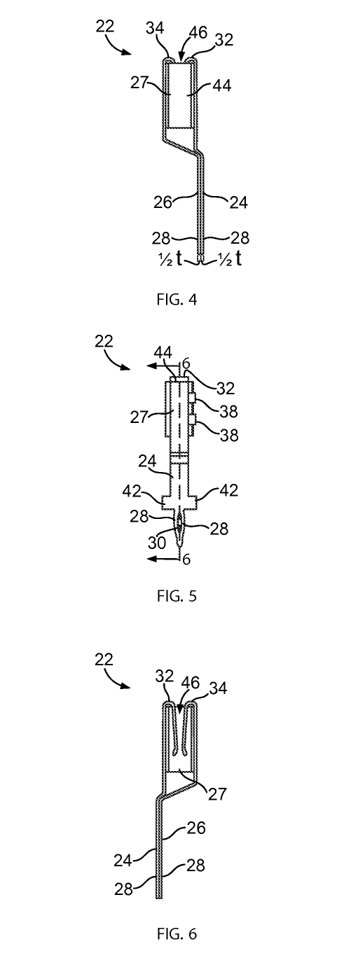

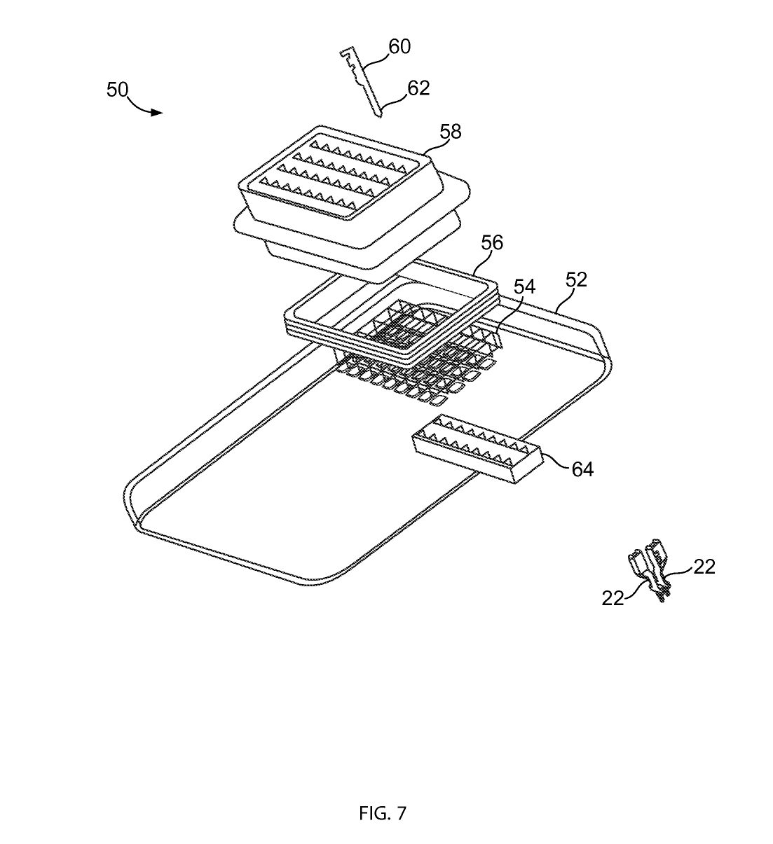

FIG. 4 illustrates a lateral view of the female contact pin 22. FIG. 5 illustrates a front view of a female contact pin 22. FIG. 6 illustrates a cross-sectional view of the female contact pin 22 through line 6-6 of FIG. 5.

As shown in FIG. 4, for example, the thickness of each leg 24 and 26 is ½t. Therefore, when the legs 24 and 26 are folded onto one another, the resulting thickness of the overlapped legs 24 and 26 is t.

As shown in FIG. 6, in particular, the opposed mating contacts 32 and 34 are configured to receive and electrically connect with a mating post of a male contact pin. That is, the mating post of the male contact pin is positioned within the clearance area 46 so that it contacts both mating contacts 32 and 34, thereby providing an electrical connection between the female contact pin 22 and the male contact pin.

FIG. 7 illustrates an isometric exploded view of an electrical system 50, according to an embodiment of the present invention. The electrical system 50 may be part of a printed circuit board, or an interface that connects or “piggybacks” separate and distinct printed circuit boards.

The system 50 includes a module housing 52 that supports a connection interface 54. A seal 56 may be positioned around the connection interface 54 and/or a portion of a bulkhead header 58.

The bulkhead header 58 connects to the connection interface 54 and is configured to receive and retain male contact pins 60, each having a mating post 62.

A female pin wafer 64 is configured to receive and retain female contact pins 22. The female pin wafer 64 connects to the connection interface 54 opposite the bulkhead header 58.

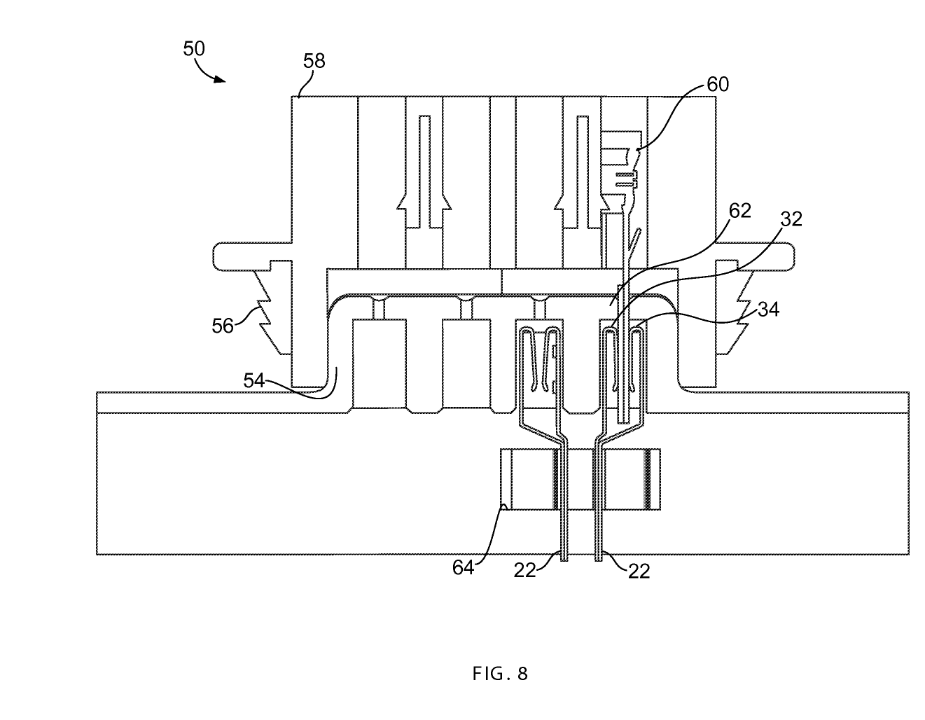

FIG. 8 illustrates a transverse cross-sectional view of the electrical system 50. As shown, the male contact pin 60 is retained within the bulkhead header 58, while the female contact pins 22 are retained within the female pin wafer 64. The mating post 62 of the male contact pin 60 passes into the connection interface 54, where it is received and retained between the mating contacts 32 and 34 of the female contact pin 22, as described above.

Referring to FIGS. 2-6, embodiments of the present invention provide a method of forming a female contact pin configured for use with a compliant pin system. The method may include integrally forming first and second legs and a planar wall from a single piece of material. Each of the first and second legs includes opposed contact beam members having an opening formed therebetween. The opposed contact beam members are configured to overlap with one another to form the opposed contact beams.

Next, the method includes bending first and second mating contact members over the planar wall. After this step, the method includes folding the first and second legs onto one another to form opposed contact beams through the overlapping opposed contact beam members. The openings of each of the first and second legs are aligned with one another to form the “eye of the needle.”

The method also includes shaping the planar wall to form a protective box around the mating contacts.

Thus, in contrast to conventional electrical pins, embodiments of the present invention provide a box-style female contact pin that includes an EOTN portion configured to be positioned within a plated thru hole. The female contact pin may be formed from a single piece of material, such as a metal sheet having a thickness of 0.0125″. The EOTN portion is doubled onto itself to create an area that is functionally 0.025″ thick.

The use of the thinner material to form the female contact pin allows for the creation of the box around the spring leg mating contacts. The box protects the mating contacts from damage.

Moreover, the box design is more forgiving when the mating posts of the male contact pins are not correctly aligned. With prior pins, it was common for mating pins to be out of plane with one another, and therefore not provide proper contact. The box design of the female contact pin allows for greater manufacturing tolerances.

Further, the mating contacts within the formed box provide redundant electrical paths, thereby reducing the chance of discontinuity during vibration and other such mechanical shocks.

Embodiments of the present invention provide a female contact pin that may be secured to a module via compliant pin termination, while also providing a box around mating contacts. That is, embodiments of the present invention combine a compliant EOTN circuit board interface with a female connector interface.

Embodiments of the present invention provide a number of advantages, including: ease of removal of a single female contact from a printed circuit board, thereby yielding less scrap of expensive, assembled printed circuit boards; and design flexibility of a traditional board-to-board system, including the ability to easily “piggyback” printed circuit boards. Further, the elimination of soldering provides for automated assembly and less thermal stress on other components within a populated printed circuit board.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A female contact pin configured for use with a compliant pin system, the female contact pin comprising:
opposed contact beams separated by an opening, wherein said opposed contact beams are configured to be positioned within a plated thru hole, and wherein said opening closes when said opposed contact beams are positioned within the plated thru hole; and
spring-biased mating contacts surrounded by a protective box, wherein said spring-biased mating contacts are configured to receive and contact a mating post of a male contact pin.

2. The female contact pin of claim 1, wherein said opposed contact beams, said spring-biased mating contacts, and said protective box are integrally formed together from a single piece of material.

3. The female contact pin of claim 2, wherein a thickness of said single piece of material is 0.0125″.

4. The female contact pin of claim 1, wherein said opposed contact beams are formed through overlapping legs.

5. The female contact pin of claim 4, wherein a thickness of said opposed contact beams is 0.025″.

6. The female contact pin of claim 1, wherein said protective box is formed from a planar wall being folded around said spring-biased mating contacts.

7. The female contact pin of claim 6, wherein said planar wall comprises at least one tab and at least one reciprocal notch configured to receive said at least one tab.

8. A method of forming a female contact pin configured for use with a compliant pin system, the method comprising:
integrally forming first and second legs and a planar wall from a single piece of material, wherein each of said first and second legs comprises opposed contact beam members having an opening formed therebetween;
bending first and second mating contact members over the planar wall;
folding the first and second legs onto one another to form opposed contact beams, wherein the openings of each of the first and second legs are aligned with one another; and
shaping the planar wall to form a protective box around the mating contacts.

9. The method of claim 8, wherein the single piece of material has a thickness of 0.0125″.

10. The method of claim 8, where a thickness of the opposed contact beams is 0.025″ after said folding.

11. The method of claim 8, wherein said shaping the planar wall comprises mating at least one tab of the planar wall with at least one notch of the planar wall.

12. A female contact pin configured for use with a compliant pin system, the female contact pin comprising:
overlapping legs that define opposed contact beams separated by an eye of the needle opening, wherein said opposed contact beams are configured to be received and retained within a plated thru hole; and
spring-biased mating contacts surrounded by a protective box, wherein said spring-biased mating contacts are configured to electrically connect to a mating post of a male contact pin.

13. The female contact pin of claim 12, wherein said opening closes when said opposed contact beams are positioned within the plated thru hole.

14. The female contact pin of claim 12, wherein said opposed contact beams, said spring-biased mating contacts, and said protective box are integrally formed together from a single piece of material.

15. The female contact pin of claim 14, wherein a thickness of said single piece of material is 0.0125″.

16. The female contact pin of claim 14, wherein a thickness of said overlapping legs is 0.025″.

17. The female contact pin of claim 14, wherein said protective box is formed from a planar wall being folded around said spring-biased mating contacts.

18. The female contact pin of claim 17, wherein said planar wall comprises at least one tab and at least one reciprocal notch configured to receive said at least one tab.
